(19) United States
(12) Patent Application Publication
(10) Pub. No.: US 2007/0031631 A1
(43) Pub. Date: Feb. 8, 2007

(54) Ultra-violet protection of data storage media

(75) Inventors: Garry R. Lundstrom, Forest Lake, MN (US); Deborah M. Jaffey, Falcon Heights, MN (US); Daniel J. Rogers, Grant, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/197,846

(22) Filed: Aug. 4, 2005

(51) Int. Cl. B32B 3/02

(52) U.S. Cl. 428/64.1

(57) ABSTRACT

The invention is directed toward techniques for shielding a reflector of a data storage medium from ultra-violet (UV) and solar radiation. Reflectors comprise materials, such as silver, that may degrade and lose their reflective properties when exposed to UV light. In some cases, exposing the reflector to UV light may degrade a recording layer positioned adjacent the reflector in a recordable data storage medium. Degradation of the reflector and/or the recording layer can lead to significant data losses in the data storage medium. The techniques described herein position a blocking material adjacent the reflector in order to protect the reflector and data stored on the data storage medium from exposure to UV light. The blocking material may comprise UV absorbing properties in order to substantially eliminate transmission of UV light through the backside of a data storage medium.

### TECHNICAL FIELD

The invention relates to data storage media and, more particularly, to protection of data stored on data storage media.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. For example, some new media formats boast improved track pitches and increased storage density using blue-wavelength lasers for data readout and/or data recording.

Optical data storage disks typically include a substrate and a reflector. In the case of read-only media, the substrate comprises a surface pattern in which data is stored. For instance, the surface pattern may be a collection of grooves or other features that define pits and lands, e.g., typically arranged in either a spiral or concentric manner. In the case of recordable media, the optical data storage disk comprises a recording layer, e.g., a phase-change layer, positioned between the substrate and the reflector. The optical data storage disks are often sealed with an additional protective layer.

Blue disk media formats, such as Blu-Ray and HD-DVD, may comprise a similar structure. The blue disk media formats may be compatible with a blue-laser drive head that operates at a wavelength of approximately 405 nm. The blue disk media formats include optically transmissive cover layers, e.g., a thin cover sheet in the case of Blu-Ray and an incident substrate in the case of HD-DVD, bonded over the optical disk with different thicknesses specified by the different blue disk media formats.

### SUMMARY

In general, the invention is directed toward techniques for protecting data stored on a data storage medium. More specifically, the techniques include shielding a reflector of a data storage medium from ultra-violet (UV) and solar radiation. Reflectors comprise materials, such as silver, that may degrade and lose their reflective properties when exposed to UV light. In some cases, exposing the reflector to UV light may degrade a recording layer positioned adjacent the reflector in a recordable data storage medium. Degradation of the reflector and/or the recording layer can lead to significant data losses in the data storage medium. The techniques described herein position a blocking material adjacent the reflector in order to protect the reflector from exposure to UV light.

Typically, data storage media include an incident substrate and a reflector deposited adjacent a backside of the incident substrate. In some conventional data storage media, only the incident substrate includes UV absorbing material in order to prevent degradation of the data stored on the data storage medium. By adding a blocking material adjacent the reflector of a data storage medium, as described herein, the invention provides complementary data protection on a backside of the data storage medium.

The blocking material may comprise UV absorbing properties in order to substantially eliminate transmission of UV light through the backside of a data storage medium. In other words, the blocking material is opaque to wavelengths of light below approximately 400 nm. The blocking material may comprise a thermal print coating, a printable surface material, a deposited film, an adhesive, a substrate, a lacquer, or a material additive to another layer in a data storage medium stack. The blocking material may be included in any type of data storage media, such as read-only or recordable CDs and DVDs, as well as high-density data storage media, such as Blu-Ray disks and HD-DVDs.

In one embodiment, the invention is directed to a data storage medium comprising a substrate, a reflector deposited adjacent the substrate, and a blocking material positioned adjacent the reflector. The blocking material substantially eliminates transmission of ultra-violet light.

In another embodiment, the invention is directed to a method of manufacturing a data storage medium comprising depositing a reflector adjacent a substrate, and positioning a blocking material adjacent the reflector. The blocking material substantially eliminates transmission of ultra-violet light.

In another embodiment, the invention is directed to a high-density data storage medium comprising a substrate, a reflector positioned adjacent a first side of the substrate, a cover layer positioned adjacent the reflector, and a blocking material positioned adjacent a second side of the substrate opposite the first side, wherein the blocking material substantially eliminates transmission of ultra-violet light.

The invention may be capable of providing one or more advantages. For example, by including a blocking material adjacent a reflector within a data storage medium, substantial reductions in reflector degradation and data loss can be achieved in the data storage medium. The processes used to build and print data storage media, such as DVD bonding adhesive, CD lacquer, printing techniques, and hardcoat application, often utilize UV curing that is destructive to both a reflector and a recording layer of the data storage media. The blocking material protects the data storage media from these destructive processes as well as other UV and solar radiation exposure. In this way, the invention maximizes archival properties of data storage media.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary data storage medium including a blocking material.

FIG. 2 is a block diagram illustrating an exemplary recordable DVD in accordance with an embodiment of the invention.

FIG. 3 is a block diagram illustrating an exemplary read-only DVD in accordance with another embodiment of the invention.

FIG. 4 is a block diagram illustrating an exemplary DVD in accordance with another embodiment of the invention.

FIG. 5 is a block diagram illustrating an exemplary recordable CD in accordance with another embodiment of the invention.

FIG. 6 is a block diagram illustrating an exemplary read-only CD in accordance with another embodiment of the invention.

FIG. 7 is a block diagram illustrating an exemplary CD in accordance with another embodiment of the invention.

FIG. 8 is a block diagram illustrating an exemplary recordable Blu-Ray disk in accordance with another embodiment of the invention.

FIG. 9 is a block diagram illustrating an exemplary read-only Blu-Ray disk in accordance with another embodiment of the invention.

FIG. 10 is a block diagram illustrating an exemplary Blu-Ray disk in accordance with another embodiment of the invention.

### DETAILED DESCRIPTION

The invention described herein provides techniques for shielding a reflector of a data storage medium from ultra-violet (UV) and solar radiation. Recordable and read-only data storage media typically include an incident substrate and a reflector deposited adjacent a backside of the incident substrate. Conventionally, UV absorber materials are only included in the incident substrate in order to protect data stored in a pre-recorded surface pattern or a recording layer of the data storage medium. However, UV and solar radiation is also prevalent on a backside of data storage media. For example, UV curing is used in many of the processes that build and print data storage media, including DVD bonding adhesive, CD lacquer, printing techniques, and hardcoat application.

Exposure to UV light may cause the reflector of a data storage medium to degrade and lose its reflective properties. For example, in the case where the reflector comprises silver, the silver can tarnish when exposed to UV light, which causes a substantial drop in reflectance. In some cases, exposing the reflector to UV light may degrade a recording layer positioned adjacent the reflector in a recordable data storage medium. The reflector may absorb the UV light, which causes the temperature of the reflector to increase. The adjacent recording layer may degrade due to the increased temperature of the reflector. Positioning a blocking material adjacent the reflector of a data storage medium substantially eliminates transmission of UV light in order to protect the reflector from exposure to UV light.

The blocking material may comprise UV absorbing properties in order to substantially eliminate transmission of UV light through the backside of a data storage medium. For example, the blocking material may be targeted to block or absorb light at wavelengths less than approximately 400 nm. The blocking material may comprise a thermal print coating, a printable surface material, a deposited film, an adhesive, a substrate, a lacquer, or a material additive to another layer in a data storage medium stack. The blocking material may be included in any type of data storage media, such as read-only or recordable CDs and DVDs, as well as high-density data storage media, such as Blu-Ray disks and HD-DVDs.

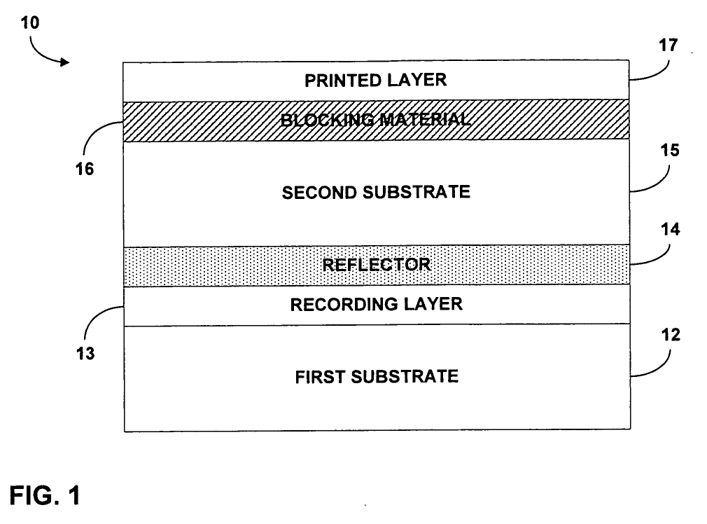

FIG. 1 is a block diagram illustrating an exemplary data storage medium 10 including a blocking material 16. Data storage medium 10 may comprise a recordable DVD, such as a DVD-R or a DVD-RW, or a recordable HD-DVD. In other embodiments, data storage medium 10 may comprise a read-only DVD or a read-only HD-DVD that includes a pre-recorded surface pattern on an incident substrate.

Data storage medium 10 includes a first substrate 12 and a recording layer 13 applied to first substrate 12 via a spin coating process. A reflector 14 may be deposited adjacent recording layer 13. Reflector 14 may comprise a substantially reflective thin film material, such as silver. In other cases, reflector 14 may comprise two or more materials combined to form a substantially reflective thin film stack. A second substrate 15 is then adhered adjacent reflector 14 with an adhesive.

When data storage medium 10 is inserted into a disk drive, first substrate 12 comprises an incident substrate to the read/write head of the disk drive. First substrate 12 and second substrate 15 may both comprise glass, silicone, or thermoplastic. In addition, first substrate 12 and second substrate 15 may be approximately the same thickness. For example, first substrate 12 and second substrate 15 are both approximately 0.6 mm thick in typical DVD and HD-DVD formats. Recording layer 13 may comprise a dye or a phase-change material capable of being recorded by the read/write head of the disk drive. Incident light from the read/write head of the disk drive is transmitted through first substrate 12 to recording layer 13 in order to read data from recording layer 13 or write data to recording layer 13. Reflector 14 reflects the light back to the read/write head to ensure accurate data reading or recording.

First substrate 12 may comprise UV absorber materials to substantially eliminate transmission of UV light from an incident side of data storage medium 10 to recording layer 13. However, UV and solar radiation may also be transmitted through a backside of data storage medium 10. Exposure to UV and solar radiation may cause reflector 14 to degrade and lose its reflective properties. This may lead to substantial data loss in data storage medium 10.

In order to protect reflector 14 from UV and solar radiation, a blocking material 16 is positioned adjacent second substrate 15. Blocking material 16 may comprise a UV absorber material capable of substantially eliminating transmission of UV light. Blocking material 16 may appear opaque to light within the UV spectrum, i.e., light at wavelengths below approximately 400 nm. Blocking material 16 may comprise a material layer formed on second substrate 15 via a deposition or spin coating process. In other embodiments, blocking material 16 may comprise a pre-formed material layer adhered to second substrate 15 via an adhesive.

Printed layer 17 is capable of receiving ink to form text or graphics that distinguish data storage medium 10. In the case of blocking material 16 comprising a material layer, printed layer 17 may be adhered to blocking material 16 with an adhesive. In other cases, blocking material 16 may comprise an adhesive and be used to adhere printed layer 17 to second substrate 15. In some embodiments, printed layer 17 may comprise multiple layers. In other embodiments, data storage medium 10 may not include printed layer 17.

Blocking material 16 substantially eliminates transmission of UV light from a backside of data storage medium 10 to reflector 14. However, placing blocking material 16 adjacent second substrate 15, as illustrated in FIG. 1, may allow at least some UV and solar radiation to reach reflector 14. For example, UV light may be able to avoid blocking material 16 and enter data storage medium 10 via light paths located between blocking material 16 and second substrate 15. Therefore the illustrated structure of data storage medium 10 may allow UV light to continue degrading reflector 14 even in the presence of blocking material 16.

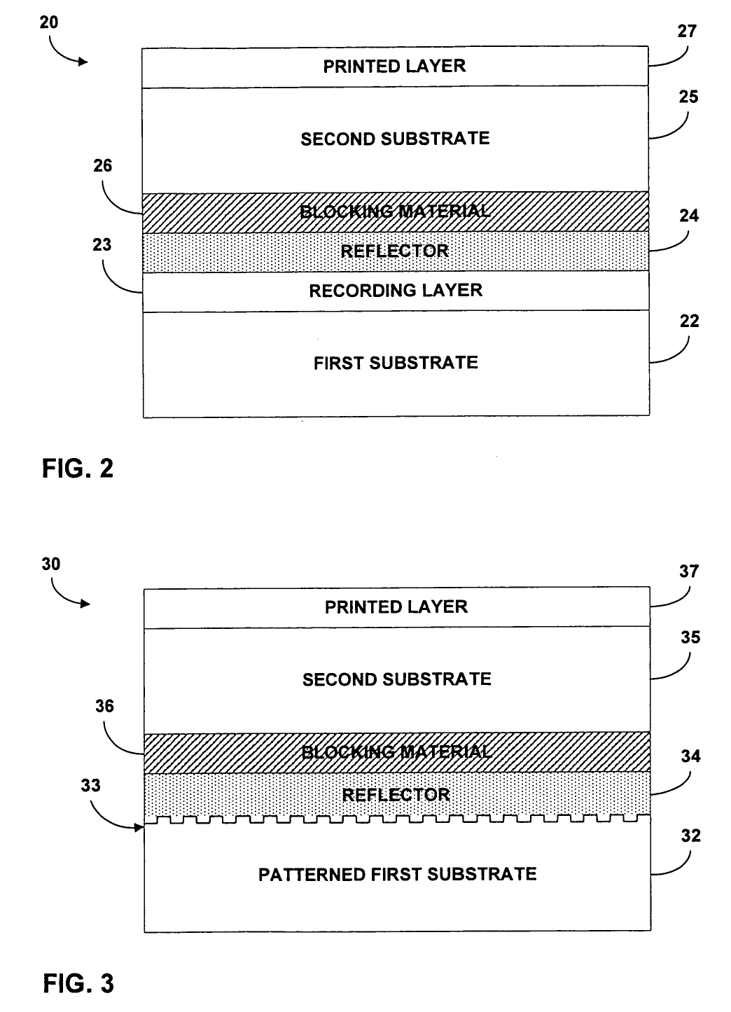

FIG. 2 is a block diagram illustrating an exemplary data storage medium 20 in accordance with an embodiment of the invention. Data storage medium 20 may comprise a recordable DVD, such as a DVD-R or a DVD-RW, or a recordable HD-DVD. Data storage medium 20 includes a first substrate 22, a recording layer 23, a reflector 24, a blocking material 26, a second substrate 25, and a printed layer 27. Printed layer 27 may be capable of receiving ink to form text or graphics that distinguish data storage medium 20. In some embodiments, printed layer 27 may comprise multiple layers. In other embodiments, data storage medium 20 may not include printed layer 27.

When data storage medium 20 is inserted into a disk drive, first substrate 22 comprises an incident substrate to the read/write head of the disk drive. First substrate 22 and second substrate 25 may both comprise glass, silicone, or thermoplastic. In addition, first substrate 22 and second substrate 25 may be approximately the same thickness. For example, first substrate 22 and second substrate 25 are both approximately 0.6 mm thick in typical DVD and HD-DVD formats.

Recording layer 23 may comprise a dye or a phase-change material capable of being recorded by the read/write head of the disk drive. Recording layer 23 may be applied to first substrate 22 via a spin coating process. Reflector 24 may be positioned adjacent recording layer 23 using a thin film deposition process. Reflector 24 may comprise a substantially reflective material, such as silver. In other cases, reflector 24 may comprises two or more materials combined to form a substantially reflective thin film stack. Incident light from the read/write head of the disk drive is transmitted through first substrate 22 to recording layer 23 in order to read data from recording layer 23 or write data to recording layer 23. Reflector 24 reflects the light back to the read/write head to ensure accurate data reading or recording.

First substrate 22 may comprise UV absorber material to substantially eliminate transmission of UV light from an incident side of data storage medium 20 to recording layer 23. However, UV and solar radiation may also be prevalent on a backside of data storage medium 20. For example, UV curing is used in many of the processes that build and print data storage media 20, including DVD bonding adhesive, printing techniques, and hardcoat application. Reflector 24 may degrade due to exposure to UV and solar radiation and cause substantial data loss in data storage medium 20. In addition, exposing reflector 24 to UV light may degrade recording layer 23 positioned adjacent reflector 24.

In order to protect reflector 24 from UV and solar radiation, a blocking material 26 is positioned adjacent reflector 24. Second substrate 25 is then positioned adjacent blocking material 26. Blocking material 26 may comprise a UV absorber material capable of substantially eliminating transmission of UV light. In other words, blocking material 26 is opaque to light at wavelengths below approximately 400 nm.

In one embodiment, blocking material 26 may comprise a material layer formed on reflector 24 via a deposition or spin coating process. Second substrate 25 may then be adhered to blocking material 26 with an adhesive. In another embodiment, blocking material 26 may comprise a material layer formed on second substrate 25 via a deposition or spin coating process. Blocking material 26 and second substrate 25 may then be adhered to reflector 24 via an adhesive. In yet another embodiment, blocking material 26 may comprise the adhesive used to adhere second substrate 25 to reflector 24. In some cases, printed layer 27 may be adhered adjacent second substrate 25 with an adhesive.

In any case, blocking material 26 is uniformly distributed across an entire surface of reflector 24 to substantially eliminate transmission of UV light from a backside of data storage medium 20. Blocking material 26 fully covers, and in some cases, overlaps reflector 24. This is especially important for reduction of data errors. If blocking material 26 only partially shields reflector 24 from UV and solar radiation, wide fluctuations may arise when reading data from data storage medium 20. These fluctuations may cause larger data errors than not protecting reflector 24 from UV exposure at all. Furthermore, unlike the embodiment illustrated in FIG. 1, data storage medium 20 positions blocking material 26 directly adjacent reflector 24 to substantially eliminate light paths that may allow UV and solar radiation to avoid blocking material 26 and reach reflector 24.

FIG. 3 is a block diagram illustrating an exemplary data storage medium 30 in accordance with another embodiment of the invention. Data storage medium 30 comprises a read-only DVD or a read-only HD-DVD. Data storage medium 30 includes a first patterned substrate 32, a reflector 34, a blocking material 36, a second substrate 35, and a printed layer 37. Printed layer 37 may be capable of receiving ink to form text or graphics that distinguish data storage medium 30. In some embodiments, printed layer 37 may comprise multiple layers. In other embodiments, data storage medium 30 may not include printed layer 37.

First patterned substrate 32 includes a pre-recorded surface pattern 33 in which data is stored. When data storage medium 30 is inserted into a disk drive, first patterned substrate 32 comprises an incident substrate to the read head of the disk drive. Reflector 34 may be positioned adjacent surface pattern 33 of first patterned substrate 32 using a thin film deposition process. Reflector 34 may comprise a substantially reflective material, such as silver, or a substantially reflective thin film stack that includes at least two different materials. Incident light from the read head of the disk drive is transmitted through first substrate 32 to surface pattern 33 in order to read data from surface pattern 33. Reflector 34 reflects the light back to the read head to ensure accurate data reading.

First patterned substrate 32 may comprise UV absorber material to substantially eliminate transmission of UV light from an incident side of data storage medium 30 to recording layer 33. In order to protect reflector 34 from UV and solar radiation on a backside of data storage medium 30, a blocking material 36 is positioned adjacent reflector 34. Second substrate 35 is then positioned adjacent blocking material 36. Blocking material 36 may comprise a UV absorber material capable of substantially eliminating transmission of UV light, i.e., light at wavelengths below approximately 400 nm.

Blocking material 36 may be positioned within data storage medium 30 substantially similar to blocking material 26 of data storage medium 20 from FIG. 2. For example, in one embodiment, blocking material 36 may comprise a material layer formed on reflector 34 via a deposition or spin coating process. Second substrate 35 may then be adhered to blocking material 36 with an adhesive. In another embodiment, blocking material 36 may comprise a material layer formed on second substrate 35 via a deposition or spin coating process. Blocking material 36 and second substrate 35 may then be adhered to reflector 34 via an adhesive. In yet another embodiment, blocking material 36 may comprise an adhesive used to adhere second substrate 35 to reflector 34.

In any case, blocking material 36 is uniformly distributed across an entire surface of reflector 34 to substantially eliminate transmission of UV light and substantially reduce data errors. Blocking material 36 fully covers, and in some cases, overlaps reflector 34. Furthermore, the structure of data storage medium 30 substantially eliminates light paths that may allow UV and solar radiation to avoid blocking material 36 and reach reflector 34.

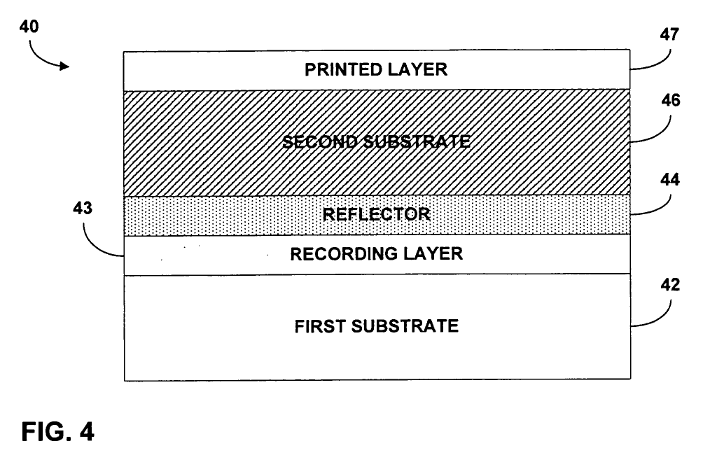

FIG. 4 is a block diagram illustrating an exemplary data storage medium 40 in accordance with another embodiment of the invention. Data storage medium 40 may comprise a recordable DVD, such as a DVD-R or a DVD-RW, or a recordable HD-DVD. In other embodiments, data storage medium 40 may comprise a read-only DVD or a read-only HD-DVD that includes a pre-recorded surface pattern in which data is stored on an incident substrate.

Data storage medium 40 includes a first substrate 42, a recording layer 43, a reflector 44, a second substrate 46, and a printed layer 47. Data storage medium 40 is constructed substantially similar to data storage medium 20 from FIG. 2. Recording layer 43 may be applied to first substrate 42 via a spin coating process. Reflector 44 may be positioned adjacent recording layer 43 using a thin film deposition process. Second substrate 46 may be adhered to reflector 44 with an adhesive. In one embodiment, a blocking material may be included within a substrate material to form second substrate 46. The blocking material may be uniformly distributed within the substrate material. In another embodiment, second substrate 46 may be formed of a substrate material that includes inherent UV blocking properties. For example, the substrate material may include polyimide, polymethyl methacrylate, or polystyrene.

First substrate 42 may comprise UV absorber material to substantially eliminate transmission of UV light from an incident side of data storage medium 40 to recording layer 43. Second substrate 46 may also comprise a UV absorber material capable of substantially eliminating transmission of UV light from a backside of data storage medium 40 to reflector 44. Second substrate 46 is uniformly distributed across an entire surface of reflector 44. As described above, this is especially important for reduction of data errors. If second substrate 46 is not uniformly distributed over reflector 44, UV and solar radiation may transmit through the unshielded portions of data storage medium 40 and degrade reflector 44.

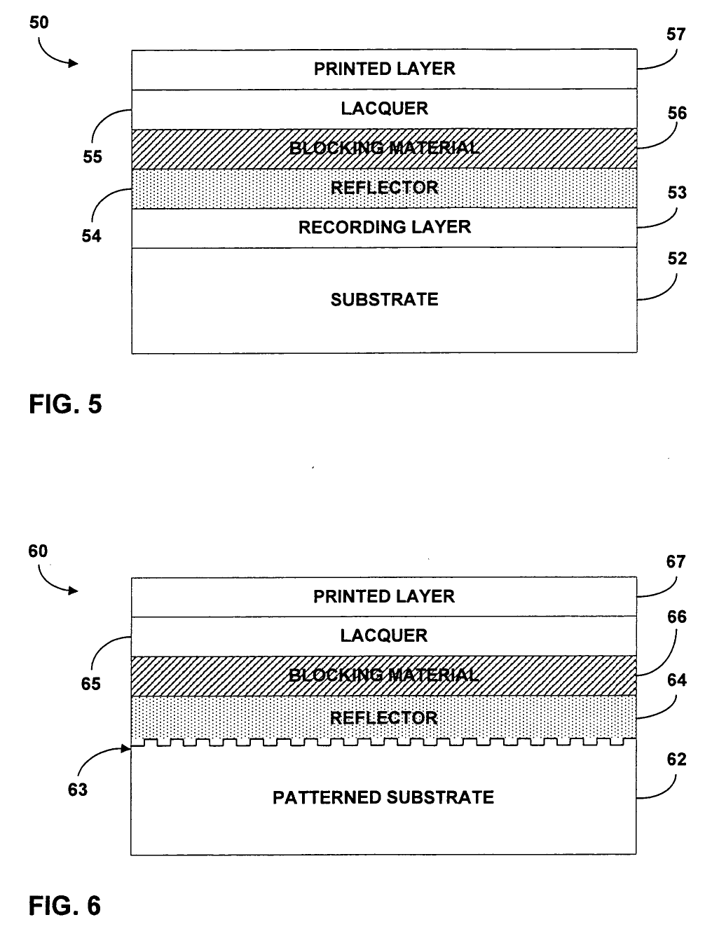

FIG. 5 is a block diagram illustrating an exemplary data storage medium 50 in accordance with another embodiment of the invention. Data storage medium 50 may comprise a recordable CD, such as a CD-R or a CD-RW. Data storage medium 50 includes a substrate 52, a recording layer 53, a reflector 54, a blocking material 56, a lacquer 55, and a printed layer 57. Printed layer 57 may be capable of receiving ink to form text or graphics that distinguish data storage medium 50. In some embodiments, printed layer 57 may comprise multiple layers. In other embodiments, data storage medium 50 may not include printed layer 57.

When data storage medium 50 is inserted into a disk drive, substrate 52 comprises an incident substrate to the read/write head of the disk drive. Substrate 52 may comprise glass, silicone, or thermoplastic. Recording layer 53 may comprise a dye or a phase-change material capable of being recorded by the read/write head of the disk drive. Recording layer 53 may be applied to substrate 52 via a spin coating process. Reflector 54 may be positioned adjacent recording layer 53 using a thin film deposition process. Reflector 54 may comprise a substantially reflective material, such as silver. In other cases, reflector 54 may comprise two or more materials combined to form a substantially reflective thin film stack. Incident light from the read/write head of the disk drive is transmitted through substrate 52 to recording layer 53 in order to read data from recording layer 53 or write data to recording layer 53. Reflector 54 reflects the light back to the read/write head to ensure accurate data reading or recording.

Substrate 52 may comprise UV absorber material to substantially eliminate transmission of UV light from an incident side of data storage medium 50 to recording layer 53. However, UV and solar radiation may also be transmitted through a backside of data storage medium 50. For example, UV curing is used in many of the processes that build and print data storage media, including CD lacquer, printing techniques, and hardcoat application. Exposure to UV and solar radiation may cause reflector 54 to degrade and lose its reflective properties. In addition, exposing reflector 54 to UV light may degrade recording layer 53 positioned adjacent reflector 54. This may lead to substantial data loss in data storage medium 50.

In order to protect reflector 54 from UV and solar radiation, a blocking material 56 is positioned adjacent reflector 54. Blocking material 56 may comprise a UV absorber material targeted to substantially eliminate transmission of UV light. For example, blocking material 56 may appear opaque to light at wavelengths below approximately 400 nm. In one embodiment, blocking material 56 may comprise a material layer formed on reflector 54 via a deposition or spin coating process. In another embodiment, blocking material 56 may comprise a pre-formed material layer adhered to reflector 54 via an adhesive. Lacquer 55 is then applied to blocking material 56 by a spin coating process. In some cases, printed layer 57 may be adhered adjacent lacquer 55 with an adhesive.

In any case, blocking material 56 is uniformly distributed across an entire surface of reflector 54 to substantially eliminate transmission of UV light from a backside of data storage medium 50. Blocking material 56 fully covers, and in some cases, overlaps reflector 54. This is especially important for reduction of data errors. If blocking material 56 only partially shields reflector 54 from UV and solar radiation, wide fluctuations may arise when reading data from data storage medium 50. These fluctuations may cause larger data errors than not protecting reflector 54 from UV exposure at all. Furthermore, unlike the embodiment illustrated in FIG. 1, data storage medium 50 positions blocking material 56 directly adjacent reflector 54 to substantially eliminate light paths that may allow UV and solar radiation to avoid blocking material 56 and reach reflector 54.

FIG. 6 is a block diagram illustrating an exemplary data storage medium 60 in accordance with another embodiment of the invention. Data storage medium 60 may comprise a read-only CD. Data storage medium 60 includes a patterned substrate 62, a reflector 64, a blocking material 66, a lacquer 65, and a printed layer 67. Printed layer 67 may be capable of receiving ink to form text or graphics that distinguish data storage medium 60. In some embodiments, printed layer 67 may comprise multiple layers. In other embodiments, data storage medium 60 may not include printed layer 67.

Patterned substrate 62 includes a pre-recorded surface pattern 63 in which data is stored. When data storage medium 60 is inserted into a disk drive, patterned substrate 62 comprises an incident substrate to the read head of the disk drive. Reflector 64 may be positioned adjacent surface pattern 63 of patterned substrate 62 using a thin film deposition process. Reflector 64 may comprise a substantially reflective material, such as silver, or a substantially reflective thin film stack that includes at least two different materials. Incident light from the read head of the disk drive is transmitted through first substrate 62 to surface pattern 63 in order to read data from surface pattern 63. Reflector 64 reflects the light back to the read head to ensure accurate data reading.

Patterned substrate 62 may comprise UV absorber material to substantially eliminate transmission of UV light from an incident side of data storage medium 60 to recording layer 63. In order to protect reflector 64 from UV and solar radiation on a backside of data storage medium 60, a blocking material 66 is positioned adjacent reflector 64. Blocking material 66 may comprise a UV opaque material that blocks or absorbs light at wavelengths of less than approximately 400 nm.

Blocking material 66 may be positioned within data storage medium 60 substantially similar to blocking material 56 of data storage medium 50 from FIG. 5. For example, in one embodiment, blocking material 66 may comprise a material layer formed on reflector 64 via a deposition or spin coating process. In another embodiment, blocking material 66 may comprise a pre-formed material layer adhered to reflector 64 via an adhesive. Lacquer 65 is then applied to blocking material 66 by a spin coating process.

In any case, blocking material 66 is uniformly distributed across an entire surface of reflector 64 to substantially eliminate transmission of UV light from a backside of data storage medium 60. Blocking material 66 fully covers, and in some cases, overlaps reflector 64. This is especially important for reduction of data errors. Furthermore, the structure of data storage medium 60 substantially eliminates light paths that may allow UV and solar radiation to avoid blocking material 66 and reach reflector 64.

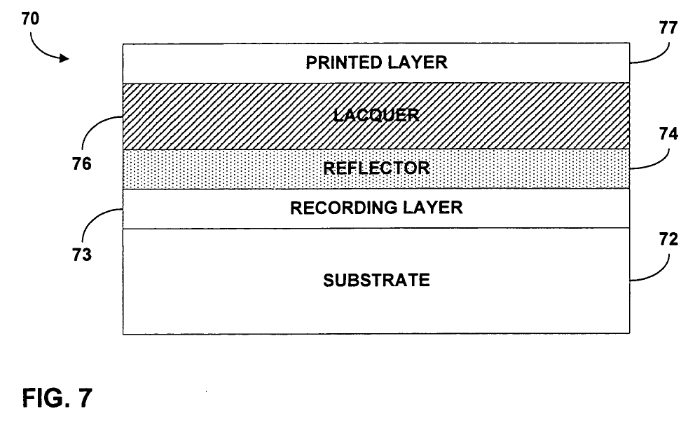

FIG. 7 is a block diagram illustrating an exemplary data storage medium 70 in accordance with another embodiment of the invention. Data storage medium 70 may comprise a recordable CD, such as a CD-R or a CD-RW. In other embodiments, data storage medium 70 may comprise a read-only CD that includes a pre-recorded surface pattern on an incident substrate.

Data storage medium 70 includes a substrate 72, a recording layer 73, a reflector 74, a lacquer 76, and a printed layer 77. Data storage medium 70 is constructed substantially similar to data storage medium 50 from FIG. 5. Recording layer 73 may be applied to substrate 72 via a spin coating process. Reflector 74 may be positioned adjacent recording layer 73 using a thin film deposition process. Lacquer 76 may be applied to reflector 74 by a spin coating process. In one embodiment, a blocking material may be included within a lacquer material to form lacquer 76. The blocking material may be uniformly distributed within the lacquer material. In another embodiment, lacquer 76 may be formed of a lacquer material that includes inherent UV blocking properties. For example, the lacquer material may include polyimide, polymethyl methacrylate, or polystyrene.

Substrate 72 may comprise UV absorber material to substantially eliminate transmission of UV light from an incident side of data storage medium 70 to recording layer 73. Lacquer 76 may also comprise a UV absorber material capable of substantially eliminating transmission of UV light from a backside of data storage medium 70 to reflector 74. Lacquer 76 may be targeted to block or absorb light at wavelengths less than approximately 400 nm. Lacquer 76 is uniformly distributed across an entire surface of reflector 74. As described above, this is especially important for reduction of data errors. If lacquer 76 is not uniformly distributed over reflector 74, UV and solar radiation may transmit through the unshielded portions of data storage medium 70 and degrade reflector 74.

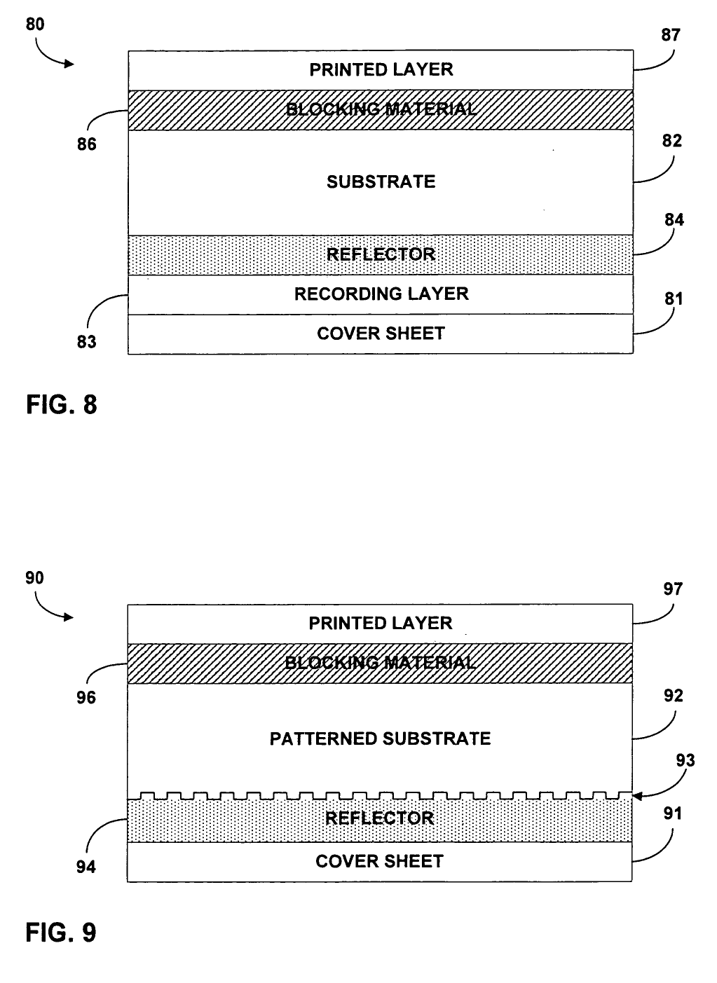

FIG. 8 is a block diagram illustrating an exemplary data storage medium 80 in accordance with another embodiment of the invention. Data storage medium 80 may comprise a recordable Blu-Ray disk. Data storage medium 80 includes a substrate 82, a reflector 84 applied to substrate 82 via a thin film deposition process, and a recording layer 83 applied to reflector 84 via a spin coating process. A cover sheet 81 may then be adhered to recording layer 83 with an adhesive.

When data storage medium 80 is inserted into a disk drive, cover sheet 81 comprises an incident cover layer to the read/write head of the disk drive. Cover sheet 81 may comprise an optically clear material. Substrate 82 may comprise glass, silicone, or thermoplastic. In typical Blu-Ray disk formats, cover sheet 81 has a thickness of approximately 0.1 mm and substrate 82 has a thickness of approximately 1.1 mm.

Recording layer 83 may comprise a dye or a phase-change material capable of being recorded by the read/write head of the disk drive. Reflector 84 may comprise a substantially reflective material, such as silver. In some cases, reflector 84 may comprise two or more materials combined to form a substantially reflective thin film stack. Incident light from the read/write head of the disk drive is transmitted through cover sheet 81 to recording layer 83 in order to read data from recording layer 83 or write data to recording layer 83. Reflector 84 reflects the light back to the read/write head to ensure accurate data reading or recording.

Cover sheet 81 may comprise UV absorber material to substantially eliminate transmission of UV light from an incident side of data storage medium 80 to reflector 84. However, UV and solar radiation may also be prevalent on a backside of data storage medium 80. Reflector 84 may degrade due to exposure to UV and solar radiation. In addition, exposing reflector 84 to UV light may degrade recording layer 83 positioned adjacent reflector 84. The degradation of reflector 84 and/or recording layer 83 may cause substantial data loss in data storage medium 80. In order to protect reflector 84 from UV and solar radiation, blocking material 86 is positioned adjacent substrate 82. As illustrated in FIG. 8, reflector 84 may be positioned adjacent a first side of substrate 82 and blocking material 86 may be positioned adjacent a second side of substrate 82 that is opposite the first side.

Blocking material 86 may comprise a UV absorber material capable of substantially eliminating transmission of UV light, i.e., light at wavelengths less than approximately 400 nm. In one embodiment, blocking material 86 may comprise a material layer formed on substrate 82 via a deposition or spin coating process. In another embodiment, blocking material 86 may comprise a pre-formed material layer adhered to substrate 82 with an adhesive.

Printed layer 87 is capable of receiving ink to form text or graphics that distinguish data storage medium 80. In the case of blocking material 86 comprising a material layer, printed layer 87 may be adhered to blocking material 86 with an adhesive. In other cases, blocking material 86 may comprise an adhesive and be used to adhere printed layer 87 to substrate 82. In some embodiments, printed layer 87 may comprise multiple layers. In other embodiments, data storage medium 80 may not include printed layer 87. In any case, blocking material 86 is uniformly applied to substrate 82 to substantially eliminate transmission of UV light from a backside of data storage medium 80 to reflector 84.

FIG. 9 is a block diagram illustrating an exemplary data storage medium 90 in accordance with another embodiment of the invention. Data storage medium 90 may comprise a read-only Blu-Ray disk. Data storage medium 90 includes a patterned substrate 92 and reflector 94 applied to patterned substrate 92 via a thin film deposition process. A cover sheet 91 may then be adhered to reflector 94 with an adhesive.

When data storage medium 90 is inserted into a disk drive, cover sheet 91 comprises an incident cover layer to the read head of the disk drive. Reflector 94 deposited over patterned substrate 92 is encoded with a surface pattern 93 in which data is stored. Reflector 94 may comprise a substantially reflective material, such as silver, or a substantially reflective thin film stack that includes at least two different materials. Incident light from the read head of the disk drive is transmitted through cover sheet 91 to surface pattern 93 in order to read data from surface pattern 93. Reflector 94 reflects the light back to the read head to ensure accurate data reading.

Cover sheet 91 may comprise UV absorber materials to substantially eliminate transmission of UV light from an incident side of data storage medium 90 to surface pattern 93. In order to protect reflector 94 from UV and solar radiation on a backside of data storage medium 90, a blocking material 96 is positioned adjacent patterned substrate 92. As illustrated in FIG. 9, reflector 94 may be positioned adjacent a first side of patterned substrate 92 and blocking materials 96 may be positioned adjacent a second side of patterned substrate 92 that is opposite the first side.

Blocking material 96 may appear opaque to light within the UV spectrum, i.e., light at wavelengths less than approximately 400 nm. Blocking material 96 may be positioned within data storage medium 90 substantially similar to blocking material 86 of data storage medium 80 from FIG. 8. For example, in one embodiment, blocking material 96 may comprise a material layer formed on substrate 92 via a deposition or spin coating process. In another embodiment, blocking material 96 may comprise a pre-formed material layer adhered to substrate 92 with an adhesive.

Printed layer 97 is capable of receiving ink to form text or graphics that distinguish data storage medium 90. In the case of blocking material 96 comprising a material layer, printed layer 97 may be adhered to blocking material 96 with an adhesive. In other cases, blocking material 96 may comprise an adhesive and be used to adhere printed layer 97 to patterned substrate 92. In some embodiments, printed layer 97 may comprise multiple layers. In other embodiments, data storage medium 90 may not include printed layer 97. In any case, blocking material 96 is uniformly applied to patterned substrate 92 to substantially eliminate transmission of UV light from a backside of data storage medium 90 to reflector 94.

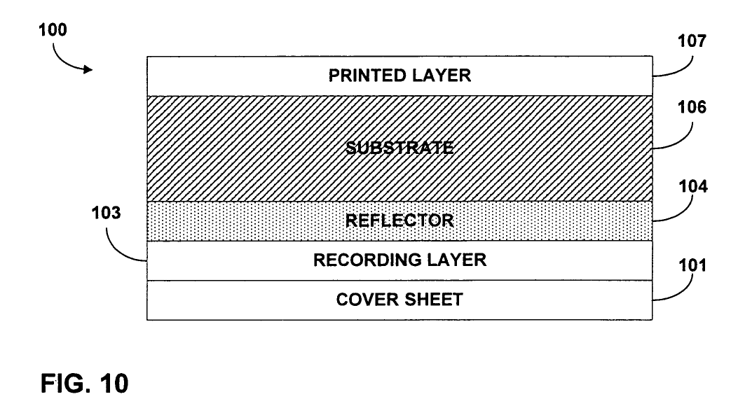

FIG. 10 is a block diagram illustrating an exemplary data storage medium 100 in accordance with another embodiment of the invention. Data storage medium 100 may comprise a recordable Blu-Ray disk. In other embodiments, data storage medium 100 may comprise a read-only Blu-Ray disk that includes a pre-recorded surface pattern on an incident substrate.

Data storage medium 100 includes a cover sheet 101, a recording layer 103, a reflector 104, a substrate 106, and a printed layer 107. Data storage medium 100 is constructed substantially similar to data storage medium 80 from FIG. 8. Reflector 104 may be positioned adjacent substrate 106 via a thin film deposition process. Recording layer 103 may be applied adjacent reflector 104 via a spin coating process. Cover sheet 101 may then be adhered adjacent recording layer 103 with an adhesive.

In one embodiment, a blocking material may be included within a substrate material to form substrate 106. The blocking material may be uniformly distributed within the substrate material. In another embodiment, substrate 106 may be formed of a substrate material that includes inherent UV blocking properties. For example, the substrate material may include polyimide, polymethyl methacrylate, or polystyrene.

Cover sheet 101 may comprise UV absorber material to substantially eliminate transmission of UV light from an incident side of data storage medium 100 to reflector 104. Substrate 106 may also comprise a UV absorber material capable of substantially eliminating transmission of UV light from a backside of data storage medium 100 to reflector 104. Substrate 106 may be targeted to block or absorb light at wavelengths less than approximately 400 nm. Substrate 106 is uniformly distributed across an entire surface of reflector 104. As described above, this is especially important for reduction of data errors. If substrate 106 is not uniformly distributed over reflector 104, UV and solar radiation may transmit through the unshielded portions of data storage medium 100 and degrade reflector 104.

Various embodiments of the invention have been described. For example, data storage media with blocking material applied adjacent a reflector of the data storage media have been described. The blocking material may include UV absorber material in order to substantially eliminate UV and solar radiation from transmitting through a backside of the data storage media to the reflector. In this way, the reflector is substantially protected against degradation and loss of reflectance. Protecting the reflector from exposure to UV light also protects a recording layer positioned adjacent the reflector in a recordable data storage medium from degradation.

The blocking material has been illustrated in recordable and read-only DVDs, recordable and read-only CDs, and recordable and read-only high-density storage media, such as HD-DVDs and Blu-Ray disks. In addition, the blocking material has been described as a separate material layer in a data storage media stack, as an adhesive used between separate layers in a data storage media stack, as a substrate within a data storage media stack, and as a material included within an existing layer in a data storage media stack.

However, the invention is not limited to the embodiments described above. A blocking material as described herein may be included in a variety of forms and structures of data storage media in order to protect the reflector of the data storage media from exposure to UV and solar radiation. These and other embodiments are within the scope of the following claims.

1. A data storage medium comprising:
a substrate;
a reflector deposited adjacent the substrate; and
a blocking material positioned adjacent the reflector, wherein the blocking material substantially eliminates transmission of ultra-violet light.

2. The data storage medium of claim 1, further comprising a recording layer positioned between the substrate and the reflector.

3. The data storage medium of claim 1, wherein the blocking material is substantially uniformly distributed across an entire surface of the reflector layer.

4. The data storage medium of claim 1, wherein the substrate is a first substrate, further comprising a second substrate positioned adjacent the blocking material.

5. The data storage medium of claim 4, wherein the blocking material is applied to the reflector via one of a deposition process or a spin coating process, and wherein the second substrate is adhered to the blocking material with an adhesive.

6. The data storage medium of claim 4, wherein the blocking material is applied to the second substrate via one of a deposition process or a spin coating process, and wherein the blocking material is adhered to the reflector with an adhesive.

7. The data storage medium of claim 4, wherein the blocking material comprises an adhesive that adheres the second substrate to the reflector.

8. The data storage medium of claim 4, further comprising a printed layer positioned adjacent the second substrate.

9. The data storage medium of claim 1, wherein the substrate is a first substrate and the blocking material is included within a second substrate.

10. The data storage medium of claim 1, wherein the substrate is a first substrate and the blocking material comprises a second substrate selected from the group consisting of polyimide, polymethyl methacrylate, and polystyrene.

11. The data storage medium of claim 1, further comprising a lacquer applied to the blocking material.

12. The data storage medium of claim 1, wherein the blocking material is included within a lacquer.

13. A method of manufacturing a data storage medium comprising:
depositing a reflector adjacent a substrate; and
positioning a blocking material adjacent the reflector, wherein the blocking material substantially eliminates transmission of ultra-violet light.

14. The method of claim 13, further comprising positioning a recording layer between the reflector and the blocking material.

15. The method of claim 13, wherein the substrate is a first substrate and positioning the blocking material comprises applying the blocking material to the reflector via one of a deposition process or a spin coating process, the method further comprising adhering a second substrate to the blocking material with an adhesive.

16. The data storage medium of claim 13, wherein the substrate is a first substrate, the method further comprising applying the blocking material to a second substrate via one of a deposition process or a spin coating process, wherein positioning the blocking material comprising adhering the blocking material to the reflector with an adhesive.

17. The method of claim 13, wherein the substrate is a first substrate and the blocking material comprises an adhesive, further comprising adhering a second substrate to the reflector with the blocking material.

18. The method of claim 13, further comprising applying a lacquer to the blocking material.

19. A high-density data storage medium comprising:
a substrate;
a reflector positioned adjacent a first side of the substrate;
a cover sheet positioned adjacent the reflector; and
a blocking material positioned adjacent a second side of the substrate opposite the first side, wherein the blocking material substantially eliminates transmission of ultra-violet light.

20. The high-density data storage medium of claim 19, further comprising a recording layer positioned between the reflector and the cover sheet.
